(19) United States
(12) Patent Application Publication
(10) Pub. No.: US 2024/0205035 A1
(43) Pub. Date: Jun. 20, 2024

(54) Managing Participants In Video Conferences

(71) Applicant: Zoom Video Communications, Inc., San Jose, CA (US)

(72) Inventors: John Andrew Alexander Beckmann, San Francisco, CA (US); Ailian Gan, San Francisco, CA (US); Nitasha Walia, Sunnyvale, CA (US); Xiaoqin Xue, Suzhou (CN); Kathy Zhou, San Francisco, CA (US)

(73) Assignee: Zoom Video Communications, Inc., San Jose, CA (US)

(21) Appl. No.: 17/908,156

(22) PCT Filed: Sep. 12, 2021
(86) PCT No.: PCT/CN2021/117873

§ 371 Date: Mar. 16, 2023

(51) Int. Cl. H04L 12/18

(52) U.S. Cl. CPC H04L 12/1818; H04L 12/1822

(57) ABSTRACT

One example method for managing participants in video conferences includes generating, by a video conferencing server, a request for a response status for each of a plurality of invitations to a video conference, each of the plurality of invitations associated with a video conference attendee, transmitting the request to a video conferencing application executed by a client device, receiving, by the video conferencing server, the response status for each of the plurality of invitations to the video conference, initiating, by the video conference server, the video conference, generating, by the video conference server, a list of each video conference attendee and the response status for each of the plurality of invitations to the video conference, and transmitting, by the video conferencing server, the list of each video conference attendee and the response status to the video conferencing application on the client device.

### FIELD

The present application generally relates to video conferencing and more particularly relates to managing participants in video conferences.

### BACKGROUND

Videoconferencing has become a common way for people to meet as a group, but without being at the same physical location. Participants can be invited to a video conference meeting, join from their personal computers or telephones, and are able to see and hear each other and converse largely as they would during an in-person group meeting or event. The advent of user-friendly video conferencing software has enabled teams to work collaboratively despite being dispersed around the country or the world. It has also enabled families and friends to engage with each other in more meaningful ways, despite being physically distant from each other.

### SUMMARY

Various examples are described for managing participants in video conferences. These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for managing participants in video conferences;

FIG. 3 shows an example system for managing participants in video conferences;

FIG. 4 shows an example graphical user interface for managing participants in video conferences;

FIG. 5 shows another example graphical user interface for managing participants in video conferences;

FIGS. 6 and 7 show example methods for managing participants in video conferences; and

FIG. 8 shows an example computing device suitable for use with example systems and methods for managing participants in video conferences.

### DETAILED DESCRIPTION

Examples are described herein in the context of managing participants in video conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

During video conferences, it can be difficult for hosts to manage the call. For example, it can be difficult once a video conference has started to determine whether all of the attendees have joined. In one example system that addresses this problem, a video conference server identifies a video conference will be occurring soon, such as in the next ninety minutes. Based on this determination, the video conferencing server sends a request to the host's client computer, asking that the client provide the response status for each user that has been invited to attend the video conference.

In response, the client device generates a request to a calendar application, such as Google's Gmail or Microsoft's Outlook, for the response status for each user. For example, when the host schedules a video conference, the host may create a calendar entry and select a plurality of users to invite to the video conference associated with the calendar entry. When the user saves the calendar entry, the calendar application sends invitations to each of the selected users in the form of an email message and stores the list of invited users in a data store.

When each user receives the email invitation, the user may choose to respond to the email. For example, the user may accept or decline the invitation after opening the invitations. When the user acts on the invitation, the user's email client generates an email, which it sends back to the host. When the host receives the message, the response is recorded by the host's email application with the calendar entry for the video conference. When the user views the calendar entry, the user can determine which users have responded and whether they have indicated that they will or will not attend. Alternatively, the user may choose to not respond. In that case, the calendar application of the host will indicate that no response has been received.

When the host's client device receives a response or responses from the calendar application, the client device then communicates a response status for each of the invitations to the video conference server. This process may occur over time. For instance, the video conference server may send the request for response status ninety minutes before the conference begins. And the client device may request and transmit response status for the plurality of invitations during the period of time before the conference begins.

At the time at which the video conference is to begin, the video conference server initiates the video conference. For example, the host may log into the video conference system and start the video conference system. In response, the video conference server provides the client device with information about the video conference and begins providing various video streams corresponding to users who have joined the video conference.

In the example system, the video conference server also generates a list of each video conference attendee along with the response status for each of the plurality of invitations to the video conference. The video conference server then transmits the list to the conferencing application on the client device. The client device displays the video conference, including the list. For example, the client device may display the list along the right side of the display in two groups: present and not yet joined. These two groups include first, those who have joined the video conference and second, those who indicated that they would join the video conference but have not yet done so. In this way, the host can determine whether everyone has joined. In some examples, the list may be grouped. For example, the list may include sub-headings that indicate with which domain each user's email address is associated with. In one example system, if the host hovers a cursor over the name of a user who has not joined, the user can then choose to communicate with the user, for instance, by sending a chat message or another invitation to join.

This illustrative example is given to introduce the reader to the general subject matter discussed herein and the disclosure is not limited to this example. The following sections describe various additional non-limiting examples and examples of managing participants in video conferences.

One example method for managing participants in video conferences includes generating, by a video conferencing server, a request for a response status for each of a plurality of invitations to a video conference, each of the plurality of invitations associated with a video conference attendee, transmitting the request to a video conferencing application executed by a client device, receiving, by the video conferencing server, the response status for each of the plurality of invitations to the video conference, initiating, by the video conference server, the video conference, generating, by the video conference server, a list of each video conference attendee and the response status for each of the plurality of invitations to the video conference, and transmitting, by the video conferencing server, the list of each video conference attendee and the response status to the video conferencing application on the client device.

One example non-transitory computer-readable medium comprises processor-executable instructions configured to cause one or more processors to: generate, by a video conferencing server, a request for a response status for each of a plurality of invitations to a video conference, each of the plurality of invitations associated with a video conference attendee, transmit the request to a video conferencing application executed by a client device, receive, by the video conferencing server, the response status for each of the plurality of invitations to the video conference, initiate, by the video conference server, the video conference, generate, by the video conference server, a list of each video conference attendee and the response status for each of the plurality of invitations to the video conference, and transmit, by the video conferencing server, the list of each video conference attendee and the response status to the video conferencing application on the client device.

One example device comprises a communications interface, a non-transitory computer-readable medium, and one or more processors configured to execute processor-executable instructions stored in the non-transitory computer-readable medium to generate, by a video conferencing server, a request for a response status for each of a plurality of invitations to a video conference, each of the plurality of invitations associated with a video conference attendee, transmit the request to a video conferencing application executed by a client device, receive, by the video conferencing server, the response status for each of the plurality of invitations to the video conference, initiate, by the video conference server, the video conference, generate, by the video conference server, a list of each video conference attendee and the response status for each of the plurality of invitations to the video conference, and transmit, by the video conferencing server, the list of each video conference attendee and the response status to the video conferencing application on the client device.

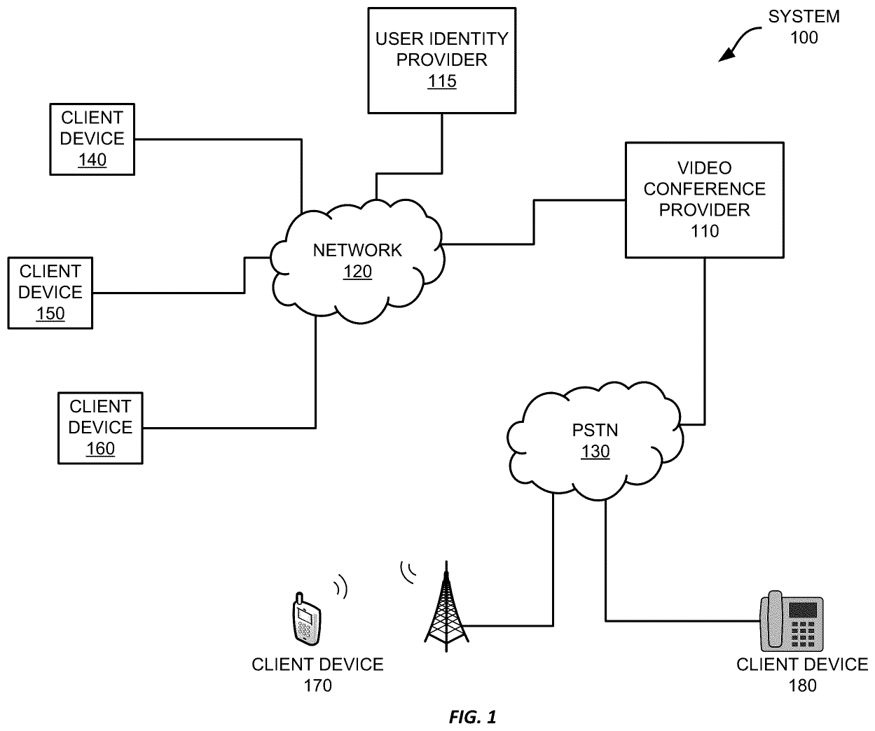

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

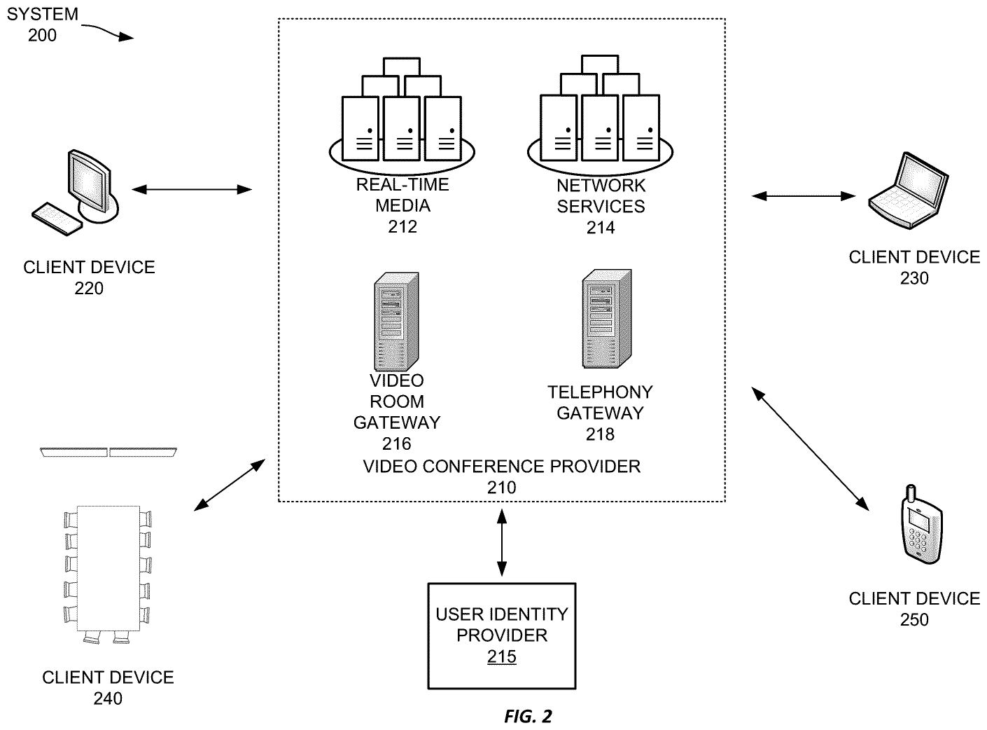

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110. If such users are able to attend a meeting in which a list of attendees is create, such users may not appear in the list of attendees that are present or have not yet joined or may be represented by some sort of indicator, such as a randomly-generated identifier.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

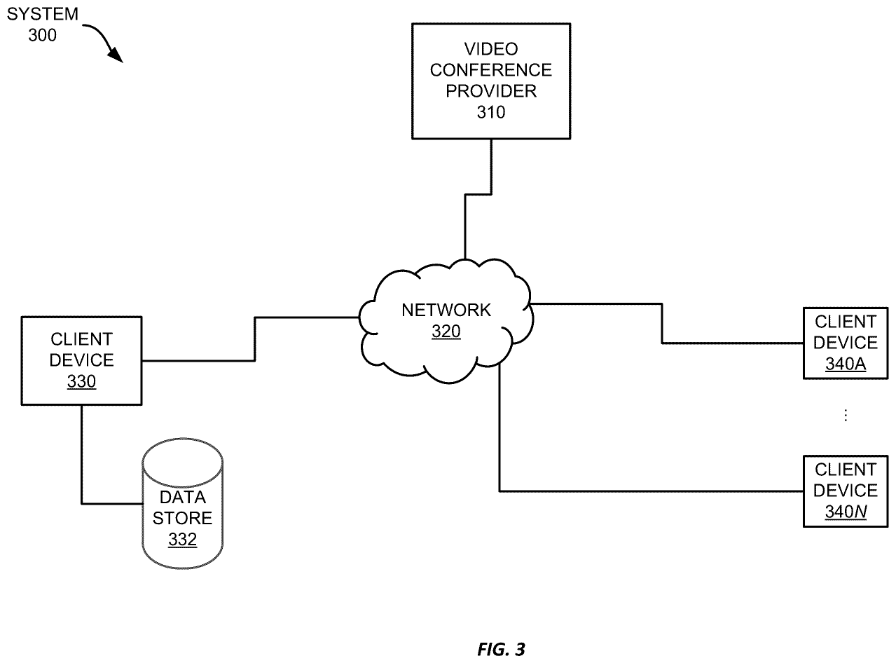

Referring now to FIG. 3, FIG. 3 shows an example system 300 for managing participants in video conferences. In this example system 300, a number of client device 330, 340a-n are connected to a video conference provider 310 via a communications network 320. In this example, the communications network 320 is the internet, however, any suitable communications network or combination of communications network may be employed, including LANs (e.g., within a corporate private LAN), WANs, etc.

Each client device 330, 340a-n executes video conference software, which connects to the video conference provider 310 and joins a meeting. During the meeting, the various participants (using video conference software at their respective client devices 330, 340a-n) are able to interact with each other to conduct the meeting, such as by viewing video feeds and hearing audio feeds from other participants, and by capturing and transmitting video and audio of themselves.

When scheduling a new meeting, a participant hosting the video conference using client device 330 executes a software application, such as a calendar application, to generate a scheduled event. As part of creating the scheduled event, the host may invite other users to attend the event. The calendar application may then generate invitations, for example email messages, that are sent to other client devices 340a-n. The list of attendees are saved in data store 332.

The invited users may then use software applications, such as email applications executing on client devices 340a-n to access and accept the invitations. Accepting an invitation generates a message back to the host at client device 330. The response can then be stored in data store 332 so that it is associated with the calendared event. For example, a scheduled event may be associated with an event identifier. The event identifier may also be associated with invitations, attendees, and responses so that the various data can be retrieve in combination with the calendar event to, for example, display a list of invited users.

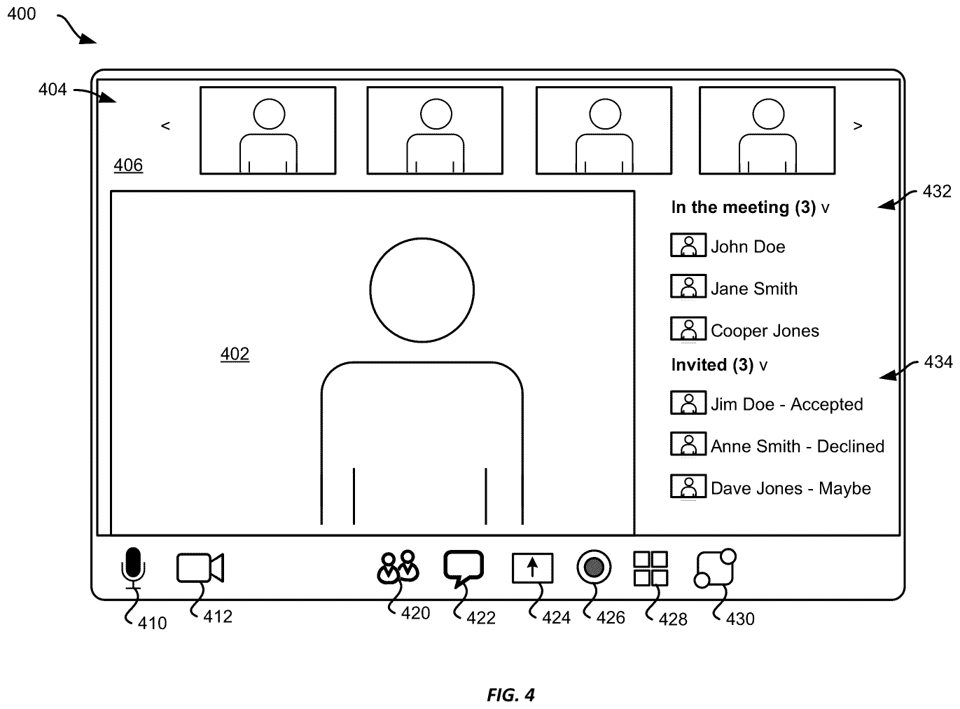

To help illustrate how a software application, e.g., software application 360, may interact with a video conferencing application, e.g., video conferencing application 350, to create a customized video conference experience, reference will be made to FIGS. 4 through 7, which illustrate different example representations of a video conference.

Referring now to FIG. 4, FIG. 4 shows an example GUI 400 presented to participants in a video conference. A client device, e.g., client device 330 or client devices 340a-n, executes video conferencing software, which in turn displays the GUI 400 on the client device's display. In this example, the GUI 400 includes a speaker view window 402 that presents the current speaker in the video conference. Above the speaker view window 402 are smaller participant windows 404, which allow the participant to view some of the other participants in the video conference, as well as controls (“<” and “>”) to let the host scroll to view other participants in the video conference. Both the speaker view window 402 and the participant windows are overlaid on a background 406, which is a solid black background in the default GUI 400.

Beneath the speaker view window 402 are a number of interactive elements 410-428 to allow the participant to interact with the video conference software. Controls 410-412 may allow the participant to toggle on or off audio or video streams captured by a microphone or camera connected to the client device. Control 420 allows the participant to view any other participants in the video conference with the participant, while control 422 allows the participant to send text messages to other participants, whether to specific participants or to the entire meeting. Control 424 allows the participant to share content from their client device. Control 426 allows the participant toggle recording of the meeting, and control 428 allows the user to select an option to join a breakout room. Finally, control 430 allows the participant to launch an application, which may integrate content into the video conference as described within this disclosure.

The GUI 400 also includes lists of users who have been invited to the meeting by the host. In the example shown, the list comprises two group: “in the meeting” 432 and “invited” 434. The users who are currently “in the meeting” are those users who were invited and are currently participating in the video conference. In the example shown in FIG. 4, three users are currently participating in the meeting. The second group “invited” 434 includes those users who were invited to the meeting but are not currently participating in the video conference. The invited list 434 also includes the response status for each of the three users in the list. For example, Jim Doe has accepted the meeting but is not present; Anne Smith has declined the meeting; and Dave Jones responded may be (or tentative) but has not yet joined. By reviewing the list 432, 434, the host can determine whether everyone invited to the meeting has joined the meeting. While these indicators are shown as text descriptions, other indications of the status of users, such as visual indicators, may be used.

The sections 432, 434 may be sorted in various ways in example systems. For example, they may be sorted by response, such as accepted, may be, declined, and no response. They may be further sorted by other attributes of the video conference participants, such by name. Further, these sections may be activated by selecting various options within the setting of the video conferencing system.

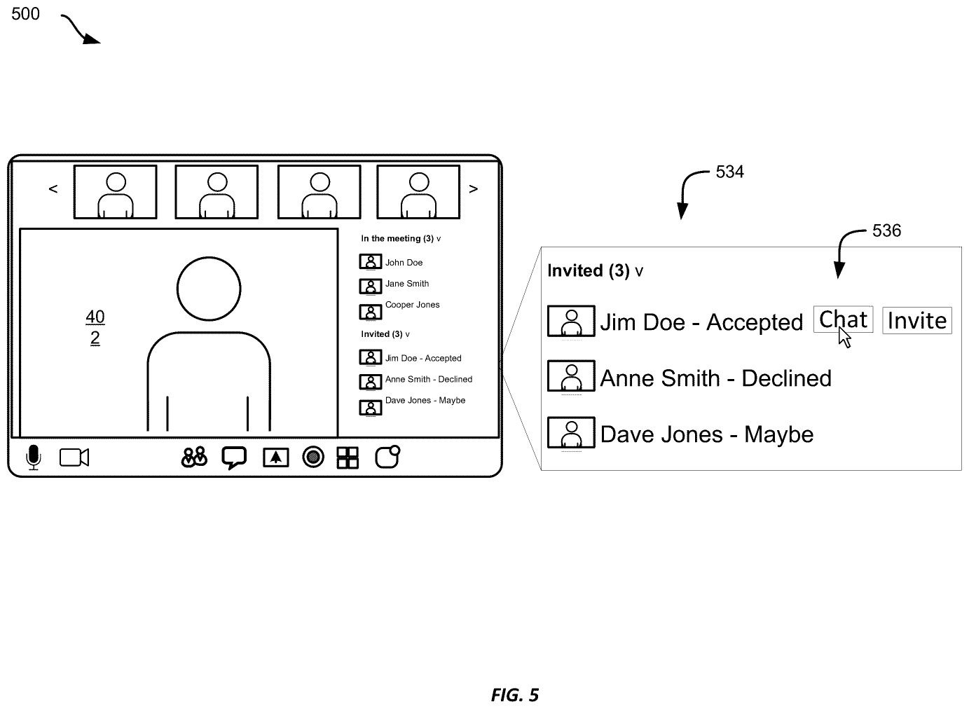

Referring now to FIG. 5, FIG. 5 shows an example GUI 500 similar to GUI 400, except that the “invited” list 534 is expanded to more clearly show the functionality of the GUI. In this case, if the user hovers the cursor over Jim Doe's name, the user is presented with selection for communicating with Jim Doe, including “Chat” 536. If the user selects “Chat”, then the video conferencing software attempts to establish a chat session with the user Jim Doe. If user Jim Doe thereafter accepts, then the user is removed from the “invited” section of the list and placed in the “in the meeting” section of the list. Other controls may also be displayed, such as “invite,” which may trigger an email message to be generated and sent to Jim Doe.

While the GUI examples shown in FIGS. 4 and 5 include only two sections, “in the meeting” and “invited,” other example interfaces may include additional list sections, such as “meeting room,” which indicates that a user has attempted to connect to the video conference but is awaiting approval from the host. Further, in some GUI examples, the sections of the list are further separated into groups. For instance, if the host invites multiple users from each of a number of different domains, e.g., multiple users whose email is in the form user.domain1.com, each of those users may be displayed within the appropriate section and further within the group for their domain. Such an interface may allow the host to more easily determine that all users from a certain domain have joined the meeting. In some examples, the sections 432, 434, 534 are only visible to the host or to alternate hosts. In other examples, any user is able to view the hosts.

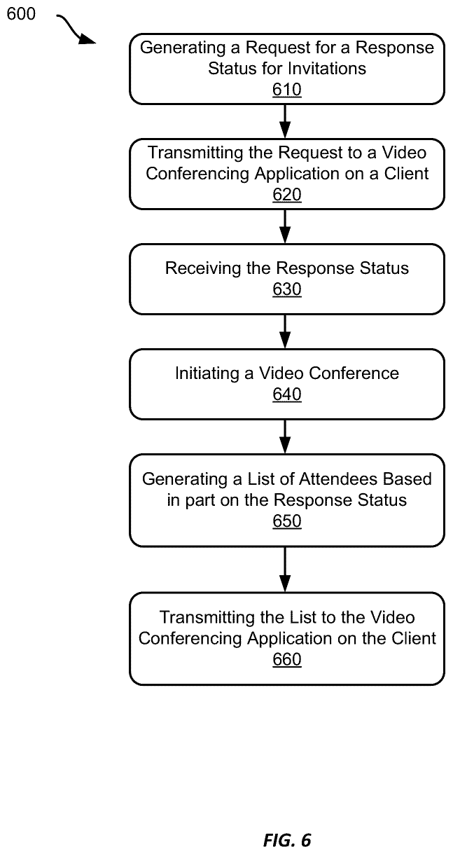

Referring now to FIG. 6, FIG. 6 shows an example method 600 for managing participants in video conferences from the perspective of a video conference provider. This example method 600 will be described with respect to the system shown in FIG. 3 and the GUI in FIG. 4; however, any suitable system according to this disclosure may be employed.

At block 610, a video conference provider 310 generates a request for a response status for invitations to participants in a video conference. For example, when a host creates a video conference, the video conference provider 310 stores information related to the video conference. The video conference provider may store a list of users to which the host has extended an invitation. In some examples, the video conference provider may store only information about the video conference itself when the video conference is created and later obtain information regarding the attendees of the video conference, for example, by issues the request for a response status as illustrated in block 610.

At block 620, the video conferencing provider 310 transmits the request to a video conferencing application executing on a client device 330. The request may comprise a single request for all invitations to a video conference. In other examples, the request comprises a plurality of requests, each request associated with a particular invited attendee or group of attendees. In some examples, the video conferencing provider 310 transmits the request a certain period of time before the video conference is scheduled to start. For instance, the video conference provider may transmit the request between thirty and ninety minutes prior to initiation of the video conference. In some examples, the time period may vary depending on the number of participants in the video conference, increasing the period as the number of invitees increases to ensure the responses are received before initiation of the video conference.

At block 630, the video conferencing provider 310 receives the response status from the client application on the client device 330. For example, the video conferencing provider may receive a list of invited users along with data for each invited user indicating whether the user responded to the meeting invitation and what response the user provided. For instance, the invited user may have accepted the meeting, responded that the user might attend the meeting, declined the meeting, or not responded to the meeting invitation. As the video conference provider 310 receives the response status, the video conference provider 310 stores the response status so that it can be subsequently retrieved. In this way, the invitee list and status are synced or propagated from the host's applications to the video conference provider 310.

At block 640, the video conferencing provider 310 initiates a video conference. For example, a host of a meeting may execute a video conference application on client device 330 and choose to start the video conference. In response, the video conference application establishes a communication link with the video conferencing provider 310 and requests that the video conference be initiated as described herein.

At block 650, the video conferencing provider 310 generates a list of attendees based in part on the response status. The list of attendees may include information, such as name, group, domain, an image associated with the attendee, or other information in addition to the response status for the video conference. The list may be created as one data set or as individual records, each corresponding to a particular user. Further, block 640 may be repeated at various instances during a video conference as attendees join and leave a video conference.

At block 660, the list is and transmitted to the client device 330 to be displayed in the video conference. For example, the client device 330 may display the GUI 400 shown in FIG. 4. And the client device 330 may use the list sent by the video conference provider to construct the sections 432, 434 displaying the various attendees and their response status.

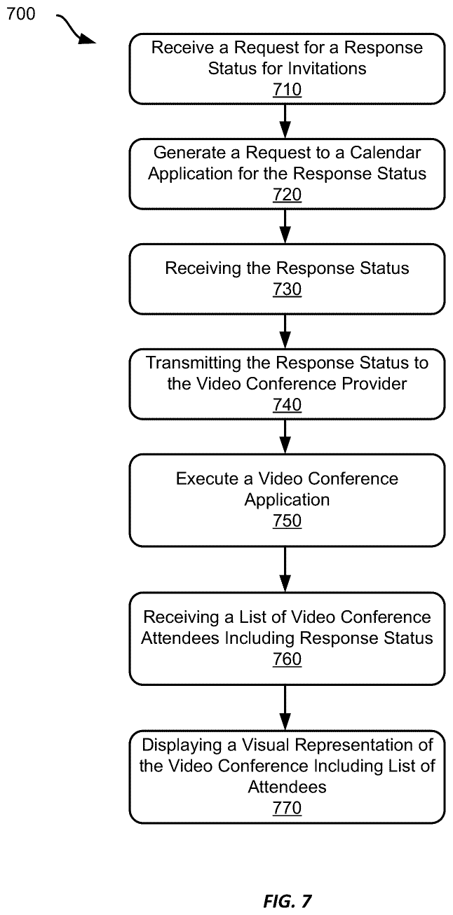

Referring now to FIG. 7, FIG. 7 shows an example method 700 for managing participants in video conferences from the perspective of a video conference application executing on a client device. This example method 700 will be described with respect to the system shown in FIG. 3 and the GUI in FIG. 4; however, any suitable system according to this disclosure may be employed.

At block 710, a video conference application executing on a client device 330 receives a request for a response status for invitations to participants in a video conference. For example, when a host creates a video conference, the host may identify users to which to send invitations to the video conference. For instance, the host may select users from a list of the host's contacts. Selecting the users may trigger a calendar application executing on client device 330 to generate and send invitations to the client devices 340a-n of the user's selected by the host.

At block 720, the video conference application generates a request to the calendar application for a response status for each of the user's to which the host directed invitations, i.e., each user invited to the video conference. The request may comprise a single request for all users or may be generated as one request per invited user. In some examples, the calendar application may comprise a plurality of calendar application. For instance, the user may maintain calendars with multiple programs, and the video conferencing application may have a mechanism for generating and transmitting requests to each of the various calendaring applications used by the host.

At block 730, the calendar application responds to the user's request with the response status. For example, the calendar application may respond that a particular invited user has accepted the invitation to the video conference. The response status may include the status of all invited users, a subset of users, or a single user.

At block 740, the video conferencing application executing on the client transmits the response status to the video conference provider. Depending on the amount of available processing and bandwidth, this response status may include all users or a subset of users, such as a single user.

At block 750, the host initiates the video conference by executing a video conferencing application on the client device 330. The host may, for example, receive a calendar reminder indicating that the schedule time to begin the meeting has arrived and including a link or control to initiate the video conference. The user's initiation of the video conference triggers a message to the video conference provider 310 to initiate the video conference as described further herein.

At block 760, the video conferencing application executing on client 330 recites the list of video conference attendees and includes the response status for each of the attendees. Using this information, the video conferencing application is able to construct the visual representation of the list.

At block 770, the client device 330 causes the video conferencing application to display a visual representation of the video conference, such as the GUI 400 depicted in FIG. 4. Each of the video streams is displayed or made available within the GUI. For example, in one system, the video conferencing application displays the “in the meeting” 432 and “invited” 434 sections depicted in FIG. 4.

While blocks 760 and 770 are depicted in FIG. 7 as occurring once, they may be repeated throughout the duration of the video conference. For example, users may become disconnected from the meeting due to a poor connection and thus be moved from the “in the meeting” section 432 to the “invited” section 434 of the GUI. When the user reconnects, assuming that the ability to rejoin is enabled for a particular meeting, the user is then placed back into the “in the meeting” section 432. This may occur multiple times. Further, if the host initiates a communication with an invited user who has not joined the meeting by, for instance, using the GUI depicted in FIG. 5, the user to whom the host directs the communication may join the video conference, triggering an update to the list. In some embodiments, the video conference provider 310 may provide the initial list, and various changes to the sections of the list may be carried out by the video conferencing application executing on the client device 330.

Such systems and methods for managing participants in a video conference provide numerous advantages. For instance, when a host initiates a video conference, the host can quickly determine if everyone has joined the video conference, thus decreasing the friction that sometimes occurs at the beginning of a video conference. Such a feature may be particularly helpful for large meetings, such as those with fifty or more participants, where it would otherwise be difficult to gauge how many users were present.

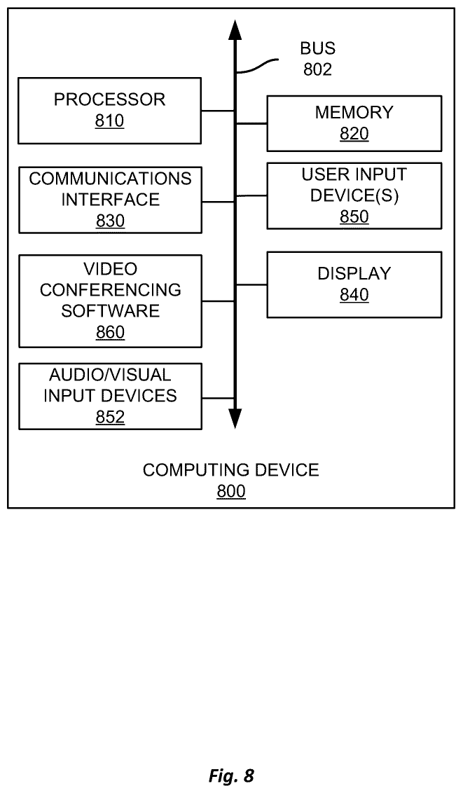

Referring now to FIG. 8, FIG. 8 shows an example computing device 800 suitable for use in example systems or methods for managing participants in video conferences according to this disclosure. The example computing device 800 includes a processor 88 which is in communication with the memory 820 and other components of the computing device 800 using one or more communications buses 802. The processor 88 is configured to execute processor-executable instructions stored in the memory 820 to perform one or more methods for providing dynamic content to video conference waiting rooms according to different examples, such as part or all of the example method described above with respect to FIG. 6. The computing device 800, in this example, also includes one or more user input devices 850, such as a keyboard, mouse, touchscreen, microphone, etc., to accept user input. The computing device 800 also includes a display 840 to provide visual output to a user.

In addition, the computing device 800 includes video conference software 860 to enable a user to join and participate in a video conference, such as a conventional meeting or webinar, by receiving multimedia streams from a video conference provider, sending multimedia streams to the video conference provider, joining and leaving breakout rooms, providing software application content, etc. such as described throughout this disclosure, etc.

The computing device 800 also includes a communications interface 840. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
generating, by a video conferencing server, a request for a response status for each of a plurality of invitations to a video conference, each of the plurality of invitations associated with a video conference attendee;
transmitting the request to a video conferencing application executed by a client device;
receiving, by the video conferencing server, the response status for each of the plurality of invitations to the video conference;
initiating, by the video conference server, the video conference;
generating, by the video conference server, a list of each video conference attendee and the response status for each of the plurality of invitations to the video conference; and
transmitting, by the video conferencing server, the list of each video conference attendee and the response status to the video conferencing application on the client device.

2. The method of claim 1, wherein transmitting the request causes the client device to generate a request to a calendar application for the response status.

3. The method of claim 2, wherein the calendar application comprises a plurality of calendar applications.

4. The method of claim 1, wherein the client device is configured to display a graphical representation of the video conference, including the list of each video conference attendee, the response status, and a current attendance status of each video conference attendee.

5. The method of claim 4, wherein the current attendance status of each video conference attendee comprises one of present or not yet joined.

6. The method of claim 1, wherein the graphical representation of the video conference comprises for each of the plurality of invitations a control for initiating communication with the conference attendee.

7. The method of claim 6, wherein the plurality of groups is associated with an Internet domain.

8. The method of claim 1, wherein transmitting the request to a video conferencing application executed by a client device comprises determining the video conference start time of the video conference and transmitting the request prior to the video conference start time.

9. A non-transitory computer-readable medium comprising processor-executable instructions configured to cause one or more processors to:
generate, by a video conferencing server, a request for a response status for each of a plurality of invitations to a video conference, each of the plurality of invitations associated with a video conference attendee;
transmit the request to a video conferencing application executed by a client device;
receive, by the video conferencing server, the response status for each of the plurality of invitations to the video conference;
initiate, by the video conference server, the video conference;
generate, by the video conference server, a list of each video conference attendee and the response status for each of the plurality of invitations to the video conference; and
transmit, by the video conferencing server, the list of each video conference attendee and the response status to the video conferencing application on the client device.

10. The non-transitory computer-readable medium of claim 9, wherein the processor-executable instructions comprising processor-executable instructions configured to cause one or more processors to transmit the request causes the client device to generate a request to a calendar application for the response status.

11. The non-transitory computer-readable medium of claim 10, wherein the calendar application comprises a plurality of calendar applications.

12. The non-transitory computer-readable medium of claim 9, wherein the client device is configured to display a graphical representation of the video conference, including the list of each video conference attendee, the response status, and a current attendance status of each video conference attendee.

13. The non-transitory computer-readable medium of claim 9, wherein the graphical representation of the video conference comprises for each of the plurality of invitations a control for initiating communication with the conference attendee.

14. The non-transitory computer-readable medium of claim 9, wherein the processor-executable instructions configured to cause one or more processors to transmit the request to a video conferencing application executed by a client device comprises processor-executable instructions configured to cause one or more processors to determine the video conference start time of the video conference and transmit the request prior to the video conference start time.

15. A device comprising:
a communications interface;
a non-transitory computer-readable medium; and
one or more processors configured to execute processor-executable instructions stored in the non-transitory computer-readable medium to:
generate, by a video conferencing server, a request for a response status for each of a plurality of invitations to a video conference, each of the plurality of invitations associated with a video conference attendee;
transmit the request to a video conferencing application executed by a client device;
receive, by the video conferencing server, the response status for each of the plurality of invitations to the video conference;
initiate, by the video conference server, the video conference;
generate, by the video conference server, a list of each video conference attendee and the response status for each of the plurality of invitations to the video conference; and
transmit, by the video conferencing server, the list of each video conference attendee and the response status to the video conferencing application on the client device.

16. The device of claim 15, wherein the processor-executable instructions comprising processor-executable instructions configured to cause one or more processors to transmit the request causes the client device to generate a request to a calendar application for the response status.

17. The device of claim 16, wherein the calendar application comprises a plurality of calendar applications.

18. The device of claim 15, wherein the client device is configured to display a graphical representation of the video conference, including the list of each video conference attendee, the response status, and a current attendance status of each video conference attendee.

19. The device of claim 18, wherein the graphical representation of the video conference comprises for each of the plurality of invitations a control for initiating communication with the conference attendee.

20. The device of claim 18, wherein the processor-executable instructions configured to cause one or more processors to transmit the request to a video conferencing application executed by a client device comprises processor-executable instructions configured to cause one or more processors to determine the video conference start time of the video conference and transmit the request prior to the video conference start time.
